(19) United States
(12) Patent Application Publication
(10) Pub. No.: US 2021/0181329 A1
(43) Pub. Date: Jun. 17, 2021

(54) RADAR DEVICE

(71) Applicant: Murata Manufacturing Co., Ltd., Kyoto (JP)

(72) Inventor: Katsuhisa KASHIWAGI, Kyoto (JP)

(21) Appl. No.: 17/168,834

(22) Filed: Feb. 5, 2021

Related U.S. Application Data
(63) Continuation of application No. PCT/JP2019/028116, filed on Jul. 17, 2019.

(30) Foreign Application Priority Data
Aug. 7, 2018 (JP) 2018-148371

(51) Int. Cl. G01S 13/58; G01S 13/931; G01S 7/35

(52) U.S. Cl. CPC G01S 13/584; G01S 2007/356; G01S 7/352; G01S 13/931

(57) ABSTRACT

A radar device includes: a single-system transmission system that transmits a frequency-modulated transmission signal; a single-system reception system that receives, as a reception signal, a reflected wave generated by the transmission signal being reflected by an object and that generates a beat signal; and a signal processing unit that detects a position of the object on the basis of the beat signal. The transmission system includes a transmission antenna that is attached to a moving body and radiates the transmission signal in a direction perpendicular to a movement direction of the moving body. The signal processing unit detects an azimuth angle of the object on the basis of a relative velocity of the object and a movement velocity of the moving body.

### CROSS REFERENCE TO RELATED APPLICATIONS

This is a continuation of International Application No. PCT/JP2019/028116 filed on Jul. 17, 2019 which claims priority from Japanese Patent Application No. 2018-148371 filed on Aug. 7, 2018. The contents of these applications are incorporated herein by reference in their entireties.

### BACKGROUND

### Technical Field

The present disclosure relates to a radar device that measures the distance to and the direction of an object, for example.

Frequency-modulated continuous wave (FMCW) radar devices that include a transmission antenna and a reception antenna are known (Non-Patent Document 1). The transmission antenna transmits a transmission signal consisting of chirp signals generated by a radio-frequency (RF) signal generator. The reception antenna receives reflected waves generated when the transmission signal is reflected by an object (target). The reflected waves received by the reception antenna are down converted into an intermediate frequency (IF) signal by a mixer and converted into a digital signal by an analog-to-digital converter (ADC). A microcomputer estimates the distance to and the direction (azimuth) of the object using the digital signal.
Non-Patent Document 1: Cesar Iovescu, Sandeep Rao, “The fundamentals of millimeter wave sensors”, Texas Instruments White Paper (www.ti.com/lit/wp/spyy005/spyy005.pdf)

### BRIEF SUMMARY

In the radar device described in Non-Patent Document 1, the distance to the object is obtaining using the used bandwidth and period of the transmission signal consisting of chirp signals and the frequency of the IF signal. In addition, when reflected waves from the object are received by a plurality of reception antennas, a phase difference is generated between a plurality of IF signals corresponding to the plurality of reception antennas. Therefore, the azimuth of the object is obtained using the phase difference between a plurality of IF signals. However, the radar device of the related art requires at least two reception systems including reception antennas in order to use the phase difference between a plurality of IF signals when identifying the azimuth of the object. Therefore, there is a problem in that the antenna surface area, the number of reception circuits (including low-noise amplifiers, mixers, filters, and so on), and power consumption increase.

The present disclosure provides a radar device that is small in size and can realize reduced power consumption.

In order to solve the above-described problem, the present disclosure provides a radar device that includes: a single-system transmission unit that transmits a frequency-modulated transmission signal; a single-system reception unit that receives, as a reception signal, a reflected wave generated by the transmission signal being reflected by an object and that generates a beat signal, which is a difference signal between the transmission signal and the reception signal; and a detection unit that detects a position of the object on the basis of the beat signal. The transmission unit includes a transmission antenna that is attached to a moving body and radiates the transmission signal in a direction perpendicular to a movement direction of the moving body. The detection unit detects an azimuth angle of the object on the basis of a relative velocity of the object and a movement velocity of the moving body.

The present disclosure enables the size and power consumption of radar devices to be reduced.

### BRIEF DESCRIPTION OF THE SEVERAL VIEWS OF THE DRAWINGS

FIG. 1 is a plan view illustrating a state in which a radar device according to an embodiment of the present disclosure has been attached to a moving body.

FIG. 2 is a block diagram illustrating the radar device in FIG. 1.

FIG. 3 is characteristic diagram illustrating changes in the frequencies of a reception signal and a beat signal with time.

FIG. 4 is a characteristic diagram illustrating changes in the frequencies of a transmission signal and a reception signal and changes in the phase of a beat signal with time.

FIG. 5 is an explanatory diagram illustrating the positional relationship between a radar device and an object.

FIG. 6A is a graph of a sensitivity expressed by a doppler effect s(θ), FIG. 6B is a graph of an adjusted antenna gain pattern, and FIG. 6C is a graph of a total sensitivity α.

FIG. 7 is a flowchart illustrating position estimation processing carried out by a signal processing unit for an object.

FIG. 8 is an explanatory diagram illustrating the relationship between the distance to an object and the relative velocity of the object as measured by a radar device.

### DETAILED DESCRIPTION

Hereafter, a radar device according to an embodiment of the present disclosure will be described in detail while referring to the accompanying drawings.

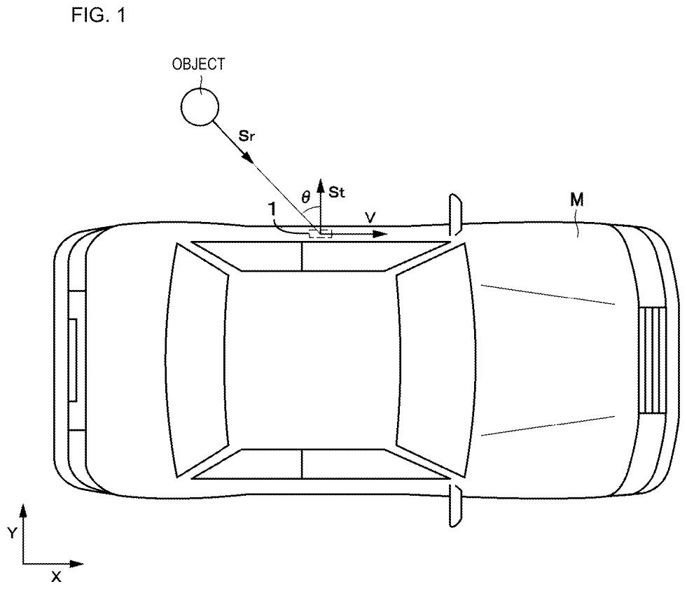

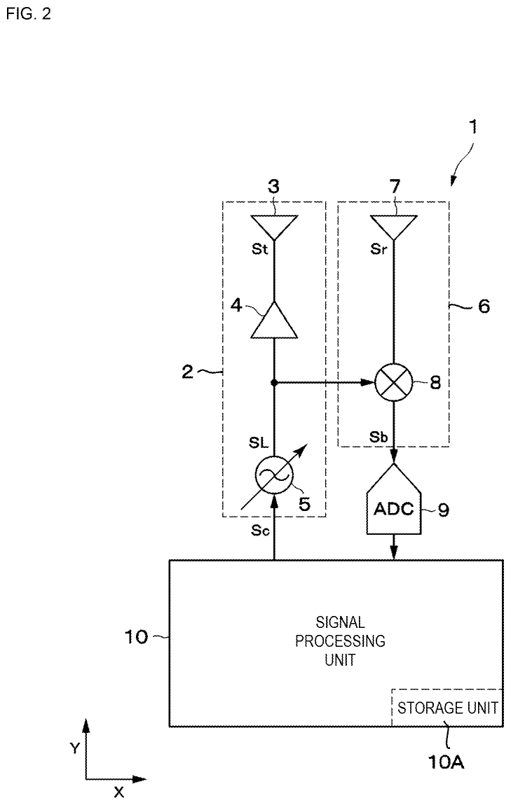

FIGS. 1 and 2 illustrate a radar device 1 according to an embodiment of the present disclosure. The radar device 1 is an FMCW-type radar device.

The radar device 1 includes a transmission system 2, which is a transmission unit, a reception system 6, which is a reception unit, and a signal processing unit 10 (e.g., a processor), which is a detection unit. The transmission system 2, the reception system 6, and the signal processing unit 10 are, for example, provided on a printed board (not illustrated). The radar device 1 is attached to a moving body M (for example, a vehicle). The moving body M moves, for example, at a movement velocity V in an X direction.

The transmission system 2 transmits a frequency-modulated transmission signal St. The transmission system 2 includes a transmission antenna 3, a power amplifier 4, and a local oscillator 5. The transmission antenna 3 radiates a local signal SL through the air as the transmission signal St. The transmission antenna 3 is formed of an omni-directional antenna, for example. The transmission antenna 3 radiates the transmission signal St in a Y direction, which is perpendicular to a direction in which the moving body M advances (X direction).

The power amplifier 4 amplifies the power of the local signal SL output from the local oscillator 5 and outputs the resulting signal to the transmission antenna 3. The local oscillator 5 oscillates the local signal SL. Specifically, the local oscillator 5 outputs the local signal SL consisting of chirp signals whose frequency linearly increases or decreases with time on the basis of a chirp control signal Sc from the signal processing unit 10. The local oscillator 5 outputs the generated local signal SL to the power amplifier 4 and a mixer 8.

The reception system 6 receives, as a reception signal Sr, reflected waves generated by the transmission signal St being reflected by an object and generates a beat signal Sb, which is a difference signal between the transmission signal St and the reception signal Sr. The reception system 6 includes a reception antenna 7 and the mixer 8. The reception system 6 may further include a low-noise amplifier and a filter. The reception antenna 7 receives the reception signal Sr consisting of reflected waves (echo signals) reflected and returning from the object when the transmission signal St is reflected by the object.

The mixer 8 outputs the beat signal Sb, which is generated from the transmission signal St (local signal SL) and the reception signal Sr, which is generated as a result of the transmission signal St being reflected by the object, received by the reception antenna 7. Specifically, the mixer 8 generates the beat signal Sb by multiplying together the reception signal Sr received by the reception antenna 7 and the local signal SL, which is the same as the transmission signal St output by the local oscillator 5. The mixer 8 is connected to the signal processing unit 10 via an ADC 9. The ADC 9 converts the beat signal Sb from an analog signal to a digital signal.

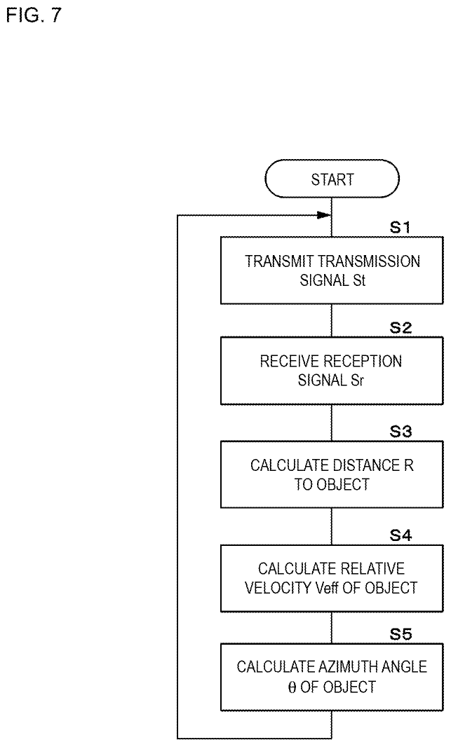

The signal processing unit 10 performs signal processing on the beat signal Sb. The beat signal Sb, which has been converted into a digital signal by the ADC 9, is input to the signal processing unit 10. The signal processing unit 10, for example, includes an FFT, a microcomputer, and so forth. In addition, the signal processing unit 10 includes a storage unit 10A. The storage unit 10A stores a position estimation processing program illustrated in FIG. 7. The signal processing unit 10 executes the position estimation processing program stored in the storage unit 10A. When the transmission signal St containing a plurality of consecutive chirp signals is transmitted, the storage unit 10A stores a corresponding beat signal Sb.

The signal processing unit 10 outputs the chirp control signal Sc to the local oscillator 5. In addition, the signal processing unit 10 performs distance measurement (ranging) and azimuth measurement to the object using the beat signal Sb output from the mixer 8.

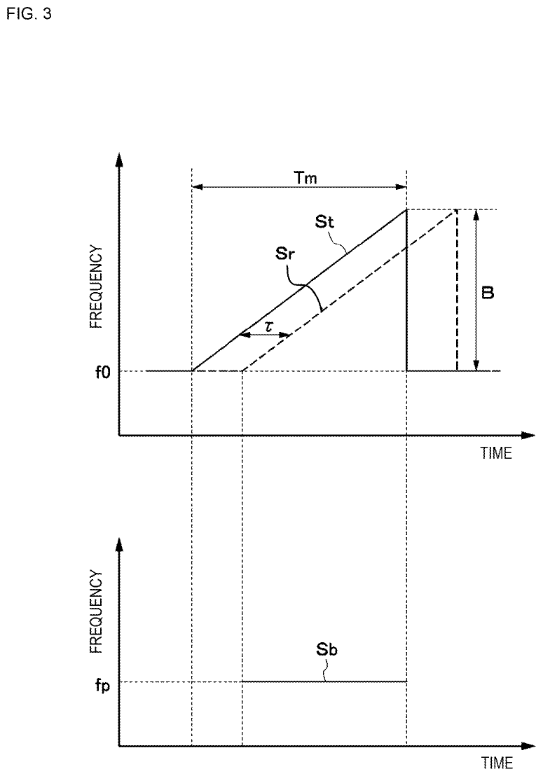

Measurement of the distance to the object performed by the signal processing unit 10 will be described while referring to FIG. 3. As illustrated in FIG. 3, the frequency of the transmission signal St linearly increases with time from f0 to f0+B in a chirp period Tm (chirp signal period). The reception signal Sr is delayed by a round trip time τ, which is the time taken for the transmission signal St to be reflected by the object and return. The frequency (peak frequency fp) of the beat signal Sb is proportional to the round trip time τ taken for the transmission signal St to be reflected by the object and return. At this time, the peak frequency fp corresponding to the round trip time τ appears in a frequency component of the beat signal Sb. Therefore, the signal processing unit 10 can detect a distance R to the object from the expression of Math 1 by detecting the peak frequency fp of the beat signal Sb. In expression of Math 1, c represents the speed of light and B represents the utilized chirp bandwidth.

$$R = \frac{cTm}{2 B} fp \qquad [ Math 1 ]$$

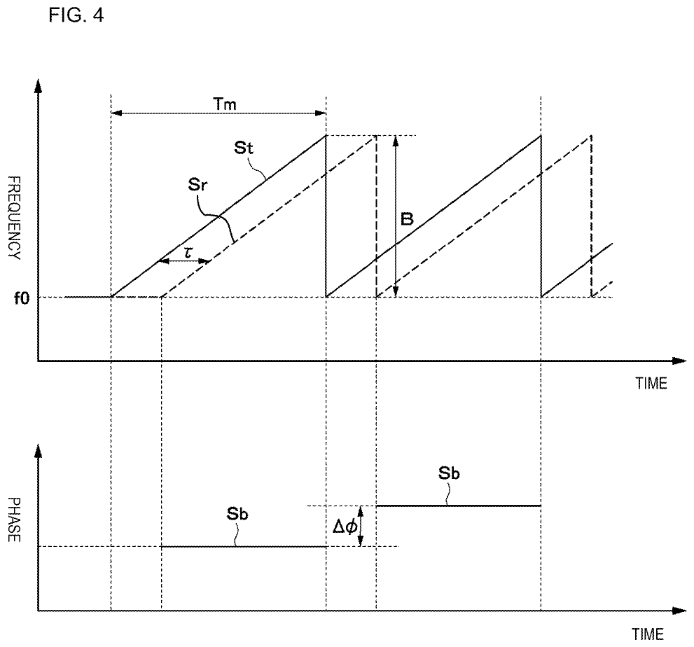

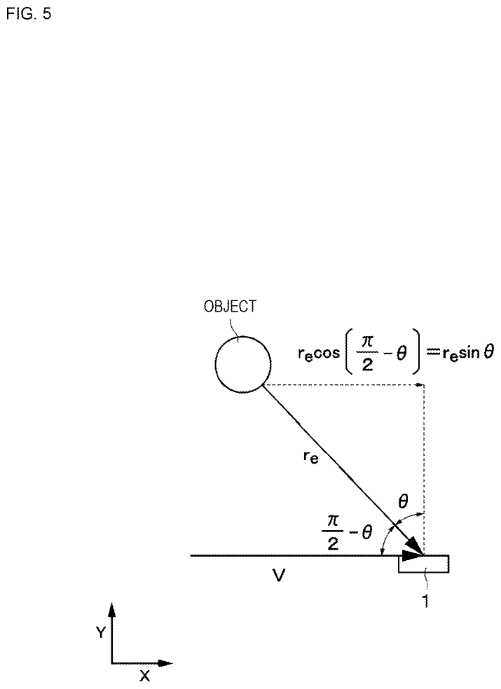

Next, measurement of the azimuth of the object performed by the signal processing unit 10 will be described while referring to FIGS. 4 and 5. FIG. 5 exemplifies a case in which an object exists in the direction of an azimuth angle θ, which is the angle with respect to the Y direction, which is perpendicular to the X direction. In this case, the azimuth angle θ corresponds to the direction of arrival of the reception signal Sr.

As illustrated in FIG. 4, the radar device 1 transmits a transmission signal St consisting of two consecutive chirp signals from the transmission antenna 3. The transmission signal St is reflected by the object, is received as the reception signal Sr by the reception antenna 7, and a beat signal Sb is generated. At this time, the beat signal Sb from the first chirp signal and the beat signal Sb from the second chirp signal have different phases from each other in accordance with a relative velocity Veff between the object and the radar device 1. The relative velocity Veff is obtained from the expression of Math 2 on the basis of a phase difference Δφ at this time. Here, λ is the wavelength of the transmission signal St in the expression of Math 2.

$$Veff = \frac{λ Δ φ}{4 π Tm} \qquad [ Math 2 ]$$

In addition, as illustrated in FIG. 5, taking a reflection direction of waves reflected from the object to the radar device 1 to be a vector r, when the moving body M moves in the X direction at the movement velocity V, the relative velocity Veff is expressed by the inner product of a unit vector re of the vector r and the vector of the movement velocity V, as described in the expression of Math 3. Therefore, the azimuth angle θ can be obtained from the expression of Math 4 on the basis of the relative velocity Veff and the movement velocity V.

$$\begin{matrix}\begin{matrix}Veff = {r}_{e} \cdot V \\ = \vert {r}_{e} \vert \vert V \vert cos ( \frac{π}{2} - θ ) \\ = \vert {r}_{e} \vert \vert V \vert sin θ \\ = \vert V \vert sin θ\end{matrix} & [ Math 3 ] \\ θ = {Sin}^{- 1} ( \frac{Veff}{\vert {r}_{e} \vert \vert V \vert} ) = {Sin}^{- 1} ( \frac{Veff}{\vert V \vert} ) & [ Math 4 ]\end{matrix}$$

In this embodiment, a gain pattern of at least one of the transmission antenna and the reception antenna may be adjusted to detect the location of obstacles accurately.

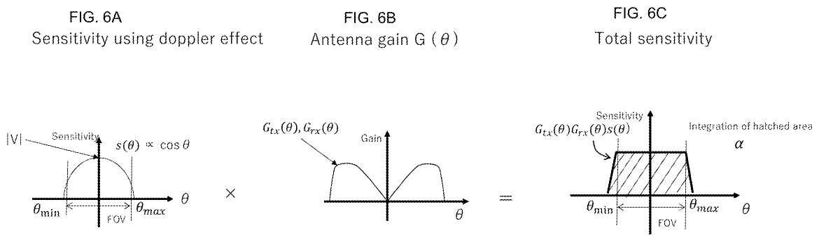

FIGS. 6A-6C show a mechanism of increasing a total sensitivity α of the radar device by adjusting a gain pattern of at least one of the transmission antenna and the reception antenna. FIG. 6A shows a sensitivity s(θ) expressed by a doppler effect before the adjustment. The sensitivity s(θ) expressed by the doppler effect at an angle θ is expressed as the expression of Math 5, in which θ represents an azimuth angle, and V represents a movement velocity, and Veff represents a relative velocity.

$$s ( θ ) = \frac{\partial Veff}{\partial θ} = \vert V \vert cos θ \qquad [ Math 5 ]$$

As shown in FIG. 6A, the sensitivity s(θ) gradually decreases toward θmin and toward θmax in a field of view (FOV), in which θmin represents the minimum angle in the viewable range (FOV) of the radar, and θmax represents the maximum angle in the viewable range (FOV) of the radar. This means that it is generally difficult for a radar device to detect an obstacle accurately at the angle where s(θ) is closes to θmin or θmax.

To improve the characteristic of the sensitivity s(θ), a gain pattern of at least one of transmission antenna and reception antenna may be adjusted as shown in FIG. 6B.

As a result of the adjustment of the gain pattern, a total sensitivity α is improved as shown in FIG. 6C. The radar device with the adjusted gain pattern is able to detect an obstacle accurately even at the angle where s(θ) is closes to or at θmin or θmax. The total sensitivity α is defined as the expression of Math 6, in which θ represents an azimuth angle, θmin represents the minimum angle in the viewable range of the radar, θmax represents the maximum angle in the viewable range of the radar, Gtx represents the gain of transmission antenna, and Grx represents the gain of reception antenna.

$$\begin{matrix}α = {\int }_{{θ}_{min}}^{{θ}_{max}} {G}_{tx} ( θ ) {G}_{rx} ( θ ) \frac{\partial Veff}{\partial θ} d θ \\ = \vert V \vert {\int }_{{θ}_{min}}^{{θ}_{max}} {G}_{tx} ( θ ) {G}_{rx} ( θ ) cos θ d θ \end{matrix} \qquad [ Math 6 ]$$

Position estimation processing performed by the signal processing unit 10 for the object will be described while referring to FIG. 7.

In step S1 in FIG. 7, the transmission signal St is transmitted from the transmission antenna 3 (refer to FIGS. 3 and 4). The transmission signal St from the transmission antenna 3 is reflected by the object and reflected waves consisting of echo signals are generated. In step S2, reflected waves from the object are received by the reception antenna 7 as the reception signal Sr. The mixer 8 generates the beat signal Sb on the basis of the reception signal Sr. The signal processing unit 10 stores the beat signal Sb in the storage unit 10A.

In step S3, the signal processing unit 10 calculates the distance R to the object from the beat signal Sb stored in the storage unit 10A. Specifically, the beat signal Sb stored in the storage unit 10A is Fourier transformed using an FFT and the peak frequency fp where the signal strength is large is detected in the frequency component of the beat signal Sb. The distance R from the radar device 1 to the object is calculated from the expression of Math 1 on the basis of the detected peak frequency fp.

In step S4, the signal processing unit 10 calculates the relative velocity Veff between the object and the radar device 1 from the beat signal Sb stored in the storage unit 10A. Specifically, the phase difference Δφ is obtained from the beat signal Sb based on a plurality of chirp signals. The relative velocity Veff is calculated from the expression of Math 2 on the basis of this phase difference Δφ.

In step S5, the azimuth angle θ is calculated on the basis of the relative velocity Veff. Specifically, the azimuth angle θ is calculated from the expression of Math 4 on the basis of the relative velocity Veff. Each time step S5 is complete, the process transitions to step S1.

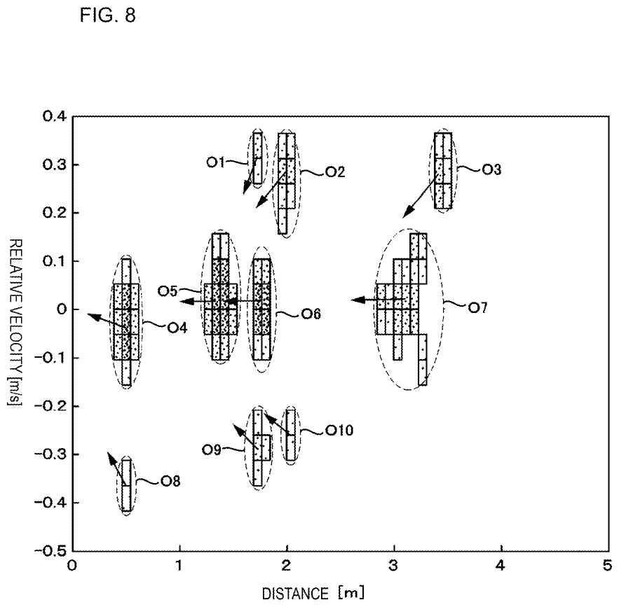

FIG. 8 illustrates results obtained by actually measuring the distances R to objects and the relative velocities Veff of the objects using the radar device 1. FIG. 8 exemplifies a case where the radar device 1 is installed in the moving body M and measures a large number of objects O1 to O10 (for example, 10). The shading in the figure represents the strengths of the waves reflected from the objects. It is illustrated that the objects O1 to O3, which are detected in a range where the relative velocity Veff is positive, are moving closer to the radar device 1. Therefore, the objects O1 to O3 are located in front of the moving body M in the movement direction of the moving body M. On the other hand, it is illustrated that the objects O8 to O10, which are detected in a range where the relative velocity Veff is negative, are moving away from the radar device 1. Therefore, the objects O8 to O10 are located behind the moving body M in the movement direction of the moving body M. It is illustrated that the objects O4 to O7 detected in a range where the relative velocity Veff is close to 0 are moving at substantially the same velocity as the radar device 1. As illustrated in FIG. 8, the radar device 1 is able to measure the distances R to the plurality of objects O1 to O10 and the relative velocities Veff of the plurality of objects O1 to O10. Therefore, the azimuth angles θ of the objects O1 to O10 can be estimated from the expression of Math 4 on the basis of the relative velocities Veff of the objects O1 to O10 and the movement velocity V of the moving body M. The arrows in FIG. 8 correspond to the azimuth angles θ of the objects O1 to O10.

Thus, in the radar device 1 according to this embodiment, the transmission system 2 includes the transmission antenna 3 that is attached to the moving body M and radiates the transmission signal St in a direction perpendicular to the movement direction of the moving body M. Therefore, the transmission signal St can be radiated over wide ranges from in front of the moving body M to behind the moving body M in the movement direction of the moving body M and it is possible to search for objects in these ranges. In addition, the signal processing unit 10 detects the azimuth angle θ of an object on the basis of the relative velocity Veff of the object and the movement velocity V of the moving body M. At this time, the relative velocity Veff of the object can be measured using a single-system transmission system 2 and a single-system reception system 6. Therefore, the radar device 1 can be reduced in size and the power consumption of the radar device 1 can be reduced compared to the related art in which a plurality of reception systems are required.

In addition, the transmission system 2 repeatedly transmits a chirp signal whose frequency linearly increases with time as the transmission signal St. The signal processing unit 10 estimates the relative velocity Veff of an object on the basis of the phase difference Δφ of the beat signal Sb generated from the transmission signal St containing chirp signals of a plurality of periods (for example, two periods) and the reception signal Sr. Therefore, the relative velocity Veff of an object can be more easily calculated on the basis of the phase difference Δφ of the beat signal Sb compared with, for example, a case where the relative velocity is estimated on the basis of changes in the beat frequency that occur with rises and falls in frequency (Doppler shift).

In this embodiment, the movement velocity V is non-zero and the moving body M needs to be moving in order to estimate the azimuth angle θ. Therefore, the azimuth angle θ of the object may be estimated using a plurality of reception systems similarly to as in the related art when the moving body M is stopped and the system may be switched to a single-system reception system to estimate the azimuth angle θ of the object when the moving body M begins to move.

In this embodiment, a chirp signal whose frequency linearly increases is used for the transmission signal St, but a chirp signal whose frequency linearly decreases may instead be used.

In the embodiment, the relative velocity Veff is detected using a beat signal based on two chirp signals. However, the present disclosure is not limited to this example and, for example, a transmission signal having a part in which the frequency rises and a part in which the frequency falls may be radiated and the relative velocity may be detected on the basis of changes that occur in the beat frequency when the frequency rises and when the frequency falls. In addition, the relative velocity may be detected on the basis of changes in the distance R with time.

In the embodiment, a case has been exemplified in which the transmission antenna 3 and the reception antenna 7 are each formed of a single antenna element. However, the present disclosure is not limited to this configuration and the transmission antenna and the reception antenna may instead be each formed of an antenna array having a plurality of antenna elements.

In the embodiment, the radar device 1 that estimates the position of an object on a two-dimensional plane has been described as an example, but the present disclosure may also be applied to a radar device that estimates the position of an object in a three-dimensional space.

The specific numerical values given in the embodiment are merely examples and the present disclosure is not limited to these values. The numerical values are to be appropriately set in accordance with the specification of the application, for example.

Next, the disclosure included in the above-described embodiment will be described. The present disclosure provides a radar device that includes: a single-system transmission unit that transmits a frequency-modulated transmission signal; a single-system reception unit that receives, as a reception signal, a reflected wave generated by the transmission signal being reflected by an object and that generates a beat signal, which is a difference signal between the transmission signal and the reception signal; and a detection unit that detects a position of the object on the basis of the beat signal. The transmission unit includes a transmission antenna that is attached to a moving body and radiates the transmission signal in a direction perpendicular to a movement direction of the moving body. The detection unit detects an azimuth angle of the object on the basis of a relative velocity of the object and a movement velocity of the moving body.

With this configuration, the transmission unit includes a transmission antenna that is attached to a moving body and radiates a transmission signal in a direction perpendicular to a movement direction of the moving body. Therefore, the transmission signal can be radiated over wide ranges from in front of the moving body to behind the moving body in the movement direction of the moving body, thereby making it is possible to search for objects in these ranges. In addition, the detection unit detects the azimuth angle of the object on the basis of the relative velocity of the object and the movement velocity of the moving body. At this time, the relative velocity of the object can be measured by a single-system transmission unit and a single-system reception unit. Therefore, the radar device can be reduced in size and the power consumption of the radar device can be reduced compared to the related art in which a plurality of reception units are required.

In the present disclosure, the transmission unit repeatedly transmits a chirp signal whose frequency linearly increases or decreases with time as the transmission signal and the detection unit estimates the relative velocity of the object on the basis of a phase difference of the beat signal generated from the transmission signal including a plurality of chirp signals and the reception signal.

Thus, the relative velocity of the object can be more easily calculated on the basis of the phase difference of the beat signal compared with, for example, a case where the relative velocity is estimated on the basis of changes in the beat frequency that occur with rises and falls in frequency.

### REFERENCE SIGNS LIST

1 radar device
2 transmission system (transmission unit)
3 transmission antenna
4 power amplifier
5 local oscillator
6 reception system (reception unit)
7 reception antenna
8 mixer
9 ADC
10 signal processing unit

1. A radar device comprising:
a single-system transmitter configured to transmit a frequency-modulated transmission signal;
a single-system receiver configured to receive a reflected wave as a reception signal and to generate a beat signal, the reflected wave being generated by the transmission signal being reflected by an object, and the beat signal being a difference signal between the transmission signal and the reception signal; and
a processor configured to detect a position of the object based on the beat signal,
wherein the transmitter comprises a transmission antenna that is attached to a moving body and that is configured to radiate the transmission signal in a direction perpendicular to a movement direction of the moving body,
wherein the processor is configured to detect an azimuth angle of the object based on a relative velocity of the object and a movement velocity of the moving body, and
wherein the relative velocity is expressed as an inner product of a unit vector rₑ of a vector r and a vector of the movement velocity V according to:
where Veff is the relative velocity, the vector r represents a reflection direction of the reflected wave, and the angle θ is the azimuth angle.

2. The radar device according to claim 1,
wherein the transmitter is configured to repeatedly transmit, as the transmission signal, a chirp signal, the chirp signal having a frequency that linearly increases or decreases with time, and
wherein the processor is configured to estimate the relative velocity of the object based on a phase difference between a plurality of beat signals generated from the repeatedly transmitted chirp signals and corresponding reception signals.

3. The radar device according to claim 1, wherein the processor is further configured to detect a distance between the object and the moving body.

4. The radar device according to claim 1, wherein the transmitter further comprises:
a local oscillator configured to receive a control signal from the processor and to output an oscillating local signal; and
a power amplifier configured to receive and amplify the oscillating local signal, and to output the transmission signal to the transmission antenna.

5. The radar device according to claim 4, wherein the receiver comprises:
a reception antenna configured to receive the reception signal; and
a mixer configured to receive the reception signal and the oscillating local signal from the local oscillator, and to output the beat signal to the processor.
